(19) United States
(12) Patent Application Publication
(10) Pub. No.: US 2026/0122718 A1
(43) Pub. Date: Apr. 30, 2026

(54) MINIMIZING PERFORMANCE DEGRADATION DURING WIRELESS TELECOMMUNICATION NETWORK RECONFIGURATION

(71) Applicant: British Telecommunications Public Limited Company, London (GB)

(72) Inventor: Richard MACKENZIE, London (GB)

(21) Appl. No.: 19/473,856

(22) PCT Filed: Mar. 7, 2024
(86) PCT No.: PCT/EP2024/056065

§ 371 Date: Oct. 9, 2025

(30) Foreign Application Priority Data
Apr. 28, 2023 (EP) 23170708.4

(51) Int. Cl. H04W 76/20; H04W 72/044

(52) U.S. Cl. CPC H04W 76/20; H04W 72/046; H04W 72/0473

(57) ABSTRACT

This invention provides a method of reconfiguring a wireless telecommunications network, and a data processing apparatus for carrying out said method, the method comprising the steps of: obtaining data indicating a reconfiguration to be made to the network; determining a plurality of transitions to implement the reconfiguration of the network, wherein it is determined, for each transition of the plurality of transitions: a change in the network to partly implement the reconfiguration, an amount of resource usage as a result of the change, and that the amount of resource usage is less than a resource usage threshold, wherein a rate of change of a first transition of the plurality of transitions is different to a rate of change of a second transition of the plurality of transitions; and causing implementation of the determined plurality of transitions.

### PRIORITY CLAIM

The present application is a National Phase Entry of PCT Application No. PCT/EP2024/056065, filed Mar. 7, 2024, which claims priority from EP Application No. 23170708.4, filed Apr. 28, 2023, each of which is hereby fully incorporated herein by reference.

### TECHNICAL FIELD

The present disclosure relates to a wireless telecommunications network and a method of reconfiguring a wireless telecommunications network.

### BACKGROUND

A wireless telecommunications network may need to be reconfigured in order to meet certain goals, such as improving user performance or to save energy. A reconfiguration may be initiated due to, for example, Coverage and Capacity Optimization (CCO), Mobility Load Balancing (MLB) or Energy Saving(ES) procedures. A reconfiguration from an initial state to the reconfigured state may have a negative impact on network performance, such as by causing additional signaling. This additional signaling reduces the amount of resources available for user traffic, and may also overwhelm the network if the amount of available resources cannot accommodate the additional signaling. In a reconfiguration scenario in which users are transferred between access points (as a consequence of the reconfiguration) and the additional signaling caused by the reconfiguration cannot be accommodated by the amount of available resources, then the user transfers may fail resulting in negative user experience.

To avoid the negative impact of a reconfiguration, a wireless telecommunications network may implement an iterative transition between an initial state and a reconfigured state. For example, a reconfiguration from a relatively large coverage area to a relatively small coverage area may be implemented as a number of iterations of coverage area reduction. The overall impact of the reconfiguration may therefore be spread out over these iterations to a manageable level.

### SUMMARY

According to a first aspect of the disclosure, there is provided a method of reconfiguring a wireless telecommunications network, the method comprising: obtaining data indicating a reconfiguration to be made to the network; determining a plurality of transitions to implement the reconfiguration of the network, wherein it is determined, for each transition of the plurality of transitions: a change in the network to partly implement the reconfiguration, an amount of resource usage as a result of the change, and that the amount of resource usage is less than a resource usage threshold, wherein a rate of change of a first transition of the plurality of transitions is different to a rate of change of a second transition of the plurality of transitions; and causing implementation of the determined plurality of transitions.

The change in the network of each transition of the plurality of transitions may be determined by iteratively: identifying a candidate change in the network to partly implement the reconfiguration, and determining the amount of resource usage as a result of the candidate change, until the amount of resource usage as a result of the candidate change is less than the resource usage threshold.

A rate of a candidate change in an iteration may be less than a rate of a candidate change in a previous iteration.

The change in the network may be one or more of a group comprising: a change in transmission power of one or more access points, a change in beam shape of one or more access points, and a change in transfer threshold for one or more respective users of one or more access points.

The determined amount of resource usage as a result of the change may be one or more of a group comprising: a spectral resource usage, a storage resource usage, and a processing resource usage.

The method may further comprise comparing a time period to implement the plurality of transitions to a predetermined reconfiguration time threshold, wherein causing implementation of the determined plurality of transitions is performed when the time period to implement the plurality of transitions is less than or equal to the predetermined reconfiguration time threshold.

The time period to implement the plurality of transitions may be greater than the predetermined reconfiguration time threshold, and the method may further comprise modifying the reconfiguration by modifying one or more of a group comprising: a final state of the network as reconfigured by the reconfiguration, the predetermined reconfiguration time threshold, and the resource usage threshold; and determining a plurality of transitions to implement the modified reconfiguration of the network, wherein it is determined, for each transition of the plurality of transitions: a change in the network to partly implement the modified reconfiguration, an amount of resource usage as a result of the change, and that the amount of resource usage is less than the resource usage threshold of the modified reconfiguration.

According to a second aspect of the disclosure, there is provided a data processing apparatus comprising a processor for carrying out the method of the first aspect of the disclosure.

According to a third aspect of the disclosure, there is provided a computer program comprising instructions which, when the program is executed by a computer, cause the computer to carry out the method of the first aspect of the disclosure. The computer program may be stored on a computer readable carrier medium.

### BRIEF DESCRIPTION OF THE FIGURES

In order that the present disclosure may be better understood, embodiments thereof will now be described, by way of example only, with reference to the accompanying drawings in which:

FIGS. 1a to 1e are schematic diagrams of a first wireless telecommunications network, illustrating the first wireless telecommunications network transitioning from an initial state in FIG. 1a to a final state in FIG. 1e.

FIGS. 2a to 2d are schematic diagrams of a second wireless telecommunications network, illustrating the second wireless telecommunications network transitioning from an initial state in FIG. 2a to a final state in FIG. 2d.

FIG. 3 is a flow diagram illustrating a method of reconfiguring the second wireless telecommunications network.

FIG. 4 is a flow diagram illustrating a method of reconfiguring the second wireless telecommunications network.

FIGS. 5a to 5c are schematic diagrams of the second wireless telecommunications network, illustrating the second wireless telecommunications network transitioning from an initial state in FIG. 5a to a final state in FIG. 5c.

FIGS. 6a to 6c are schematic diagrams of the second wireless telecommunications network, illustrating the second wireless telecommunications network transitioning from an initial state in FIG. 6a to a final state in FIG. 6c.

### DETAILED DESCRIPTION

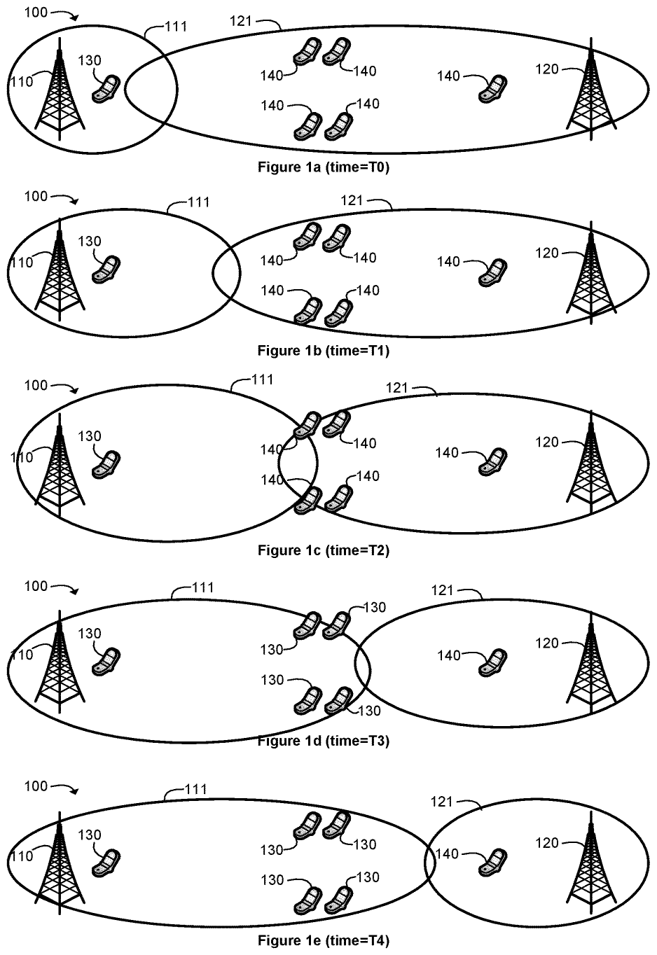

FIG. 1a illustrates a first wireless telecommunications network 100 having a first access point 110, a second access point 120, and a plurality of users. FIG. 1a illustrates an initial state of the first wireless telecommunications network 100 in which the first access point 110 has an initial coverage area 111 and the second access point 120 has an initial coverage area 121. The plurality of users are divided between a first set 130 that are within the coverage area 111 of the first access point 110 (and therefore served by the first access point 110) and a second set 140 that are within the coverage area 121 of the second access point 120 (and therefore served by the second access point 120).

FIG. 1a to 1e illustrate a reconfiguration of coverage areas 111, 121 of the first and second access points 110, 120 of the first wireless telecommunications network 100 from their respective initial states shown in FIG. 1a to their respective final states shown in FIG. 1e. The reconfiguration is performed iteratively such that the overall change in coverage area is implemented as a number of iterations of smaller changes in coverage area (illustrated in FIGS. 1a to 1e). The change in coverage area in each iteration is approximately equal (as a result of a proportionate change in transmission power for each access point in each iteration).

It can be seen from FIGS. 1a to 1e that the change in coverage areas 111, 121 of the first and second access points 110, 120 from timestep T0 to T1 (illustrated as the transition from FIG. 1a to FIG. 1b) and the change in coverage areas 111, 121 of the first and second access points 110, 120 from timestep T1 to T2 (illustrated as the transition from FIG. 1b to FIG. 1c) does not result in any transfer of users between the first access point 110 and second access point 120 (i.e. between the first set 130 and the second set 140). The change in coverage areas 111, 121 of the first and second access points 110, 120 from timestep T2 to T3 (illustrated as the transition from FIG. 1c to FIG. 1d) results in four users currently being served by the second access point 120 satisfying a transfer condition so as to each initiate a transfer from the second access point 120 to the first access point 110 (i.e. to initiate a transfer from the second set 140 to the first set 130). Lastly, the change in coverage areas 111, 121 of the first and second access points 110, 120 from timestep T3 to T4 (illustrated in the transition from FIG. 1d to FIG. 1e) does not result in any transfer of users between the first set 130 and second set 140.

There are a number of problems with the above solution. Firstly, the changes in coverage areas 111, 121 of the first transition (FIG. 1a to FIG. 1b), second transition (FIG. 1b to FIG. 1c) and fourth transition (FIG. 1d to FIG. 1e) do not result in any transfers such that resources that may have been utilized for performing these transfers are not employed. In other words, the time periods of these transitions are effectively wasted. Furthermore, the changes in coverage areas 111, 121 of the third transition (FIG. 1c to 1d) cause a spike in user transfers. This spike in user transfers causes additional signaling which may use an unsatisfactory amount of the overall resources in the network 100, such that these resources cannot be used for more desirable services (such as data transfer). This additional signaling may also overwhelm the network if it cannot be accommodated by the available resources, which may result in failed transfers and negative user experience as a result of such failed transfers.

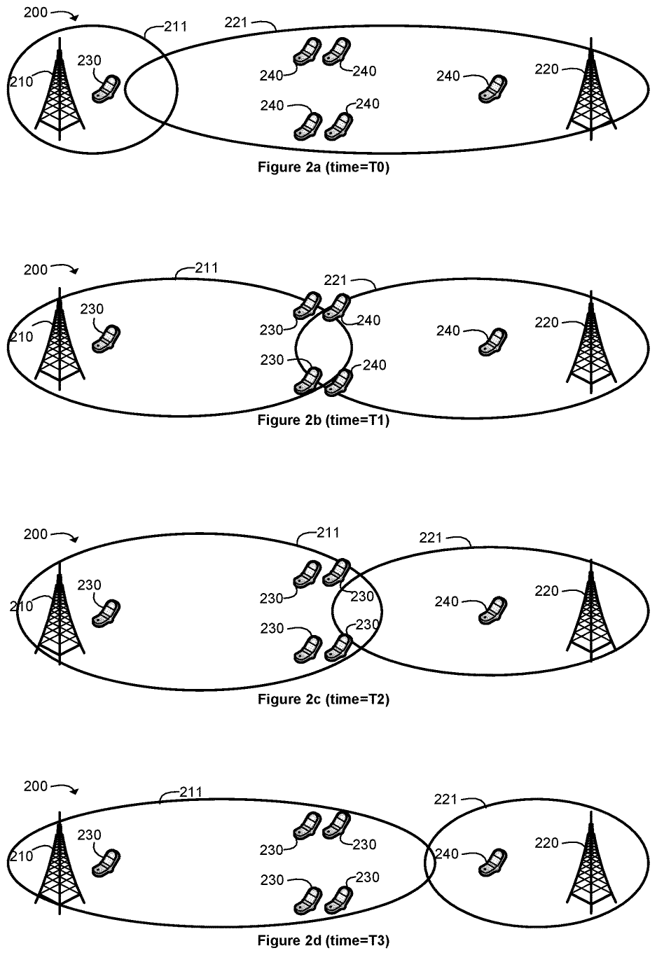

FIG. 2a illustrates a second wireless telecommunications network 200 having a first access point 210, a second access point 220, and a plurality of users. FIG. 2a illustrates an initial state of the second wireless telecommunications network 200 in which the first access point 210 has an initial coverage area 211 and the second access point 220 has an initial coverage area 221. The plurality of users are divided between a first set 230 that are within the coverage area 211 of the first access point 210 (and therefore served by the first access point 210) and a second set 240 that are within the coverage area 221 of the second access point 220 (and therefore served by the second access point 220).

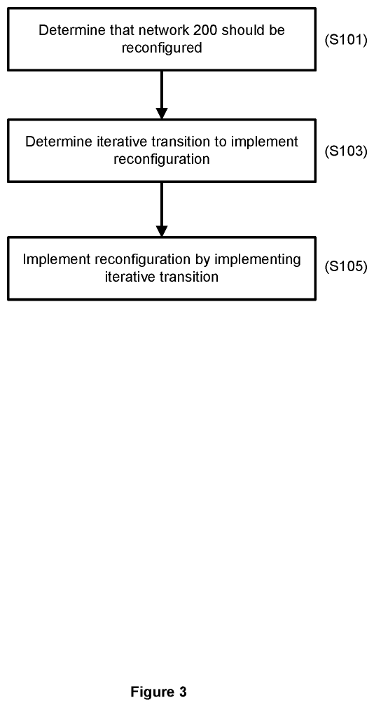

FIG. 2a to FIG. 2d illustrates a reconfiguration of coverage areas 211, 221 of the first and second access points 210, 220 of the second wireless telecommunications network 200 from their respective initial states shown in FIG. 2a to their respective final states shown in FIG. 2d. For the purposes of comparison, the respective initial states shown in FIG. 2a, the respective final states shown in FIG. 2d, and a distribution of the plurality of users in the second wireless telecommunications network 200 are the same as the first wireless telecommunications network 100. The reconfiguration of the second wireless telecommunications network 200 is performed by implementation of a method illustrated in FIG. 3 and alleviates the aforementioned problems of the reconfiguration of the first wireless telecommunications network 100 illustrated in FIG. 1a to FIG. 1e.

S101 of the method illustrated in FIG. 3 is a trigger event in which it is determined that the network 200 should be reconfigured. This reconfiguration may be the result of, for example, a Coverage and Capacity Optimization (CCO), Mobility Load Balancing (MLB) or Energy Saving(ES) procedure. In this example, the reconfiguration is to change the respective transmission powers of the first and second access points 210, 220 from their respective initial states (corresponding to the respective coverage areas 211, 221 of the first and second access points 210, 220 shown in FIG. 2a) to the respective transmission powers of the first and second access points 210, 220 in their respective final states (corresponding to the respective coverage areas 211, 221 of the first and second access points 210, 220 in their final states shown in FIG. 2d).

In S103, the network 200 determines an iterative transition to implement the reconfiguration, in which each iteration implements a respective change in transmission powers of the first and second access points 210, 220 (to partly implement the reconfiguration) and an amount of resource usage as a result of the respective change is less than a threshold. The change transmission power of the first access point 210 in the first iteration may be implemented at a different rate of change relative to the change in transmission power of the first access point 210 in the second iteration (resulting in the change in coverage area 211 in the first iteration being implemented at a different rate of change relative to the change in coverage area 211 in the second iteration). Similarly, the change transmission power of the second access point 220 in the first iteration may be implemented at a different rate of change relative to the change in transmission power of the second access point 220 in the second iteration (resulting in the change in coverage area 221 in the first iteration being implemented at a different rate of change relative to the change in coverage area 221 in the second iteration). In the example shown in FIG. 2a to FIG. 2d, the changes in coverage areas 211, 221 of the first and second access points 210, 220 from timestep T0 to T1 (illustrated as the transition from FIG. 2a to FIG. 2b), the changes in coverage areas 211, 221 of the first and second access points 210, 220 from timestep T1 to T2 (illustrated as the transition from FIG. 2b to FIG. 2c), and the changes in coverage areas 211, 221 of the first and second access points 210, 220 from timestep T2 to T3 (illustrated as the transition from FIG. 2c to FIG. 2d) are of unequal size (such that, for a common time period between timesteps, the rate of change in coverage area differs in the three transitions). The transmission powers of each access point 210, 220 are calculated for each iteration such that the amount of resource usage as a result of the change (in this example, the rate of transfer of users, such as by handover and/or cell reselection) in each iteration is less than a threshold.

The process of FIG. 2a to FIG. 2d illustrates a number of benefits. Firstly, it ensures that the rate of transfer of users is kept below a certain amount that the network operator considers manageable. The threshold may be set so as to reduce the number of failed transfers, which would otherwise result in poor user experience. The threshold may also be set to limit the additional signaling caused by the transfers, thereby ensuring a certain amount of resources available for more desirable services (such as data transfer).

Another benefit of the process of FIG. 2a to FIG. 2d is that the rate of change of coverage area in each iteration may be increased (relative to the equal rate of change of coverage area in each iteration of the process illustrated in FIG. 1a to FIG. 1e), or maximized, within a limit such that the consequent rate of transfer of users is within the threshold. In other words, the rate of change in each iteration may be set at the maximum rate of change such that the rate of transfer of users as a result of each change is less than a threshold. As noted above, the time periods of some transitions of the process illustrated in FIG. 1a to FIG. 1e were wasted as no users were transferred as a result of these transitions of the first and second access points 110, 120. For example, the time period of the first transition from timestep T0 in FIG. 1a to timestep T1 in FIG. 1b was wasted as no users were transferred. However, in the same time period from timestep T0 to timestep T1, illustrated as the transition from FIG. 2a to FIG. 2b, a relatively large coverage area change (corresponding to a relatively large rate of change) resulted in two users transfers. Accordingly, the benefits of the reconfiguration are realized by these two users at an earlier time. Furthermore, this increased rate of change reduces the overall time required to implement the reconfiguration. This is illustrated by comparison of the process illustrated in FIG. 1a to FIG. 1e with the process illustrated in FIG. 2a to FIG. 2d (which illustrates the same initial state, same final state, and same plurality of users), in which the process illustrated in FIG. 2a to FIG. 2d is implemented in a shorter time period.

In S105, the network 200 causes implementation of the reconfiguration by implementing the iterative transition.

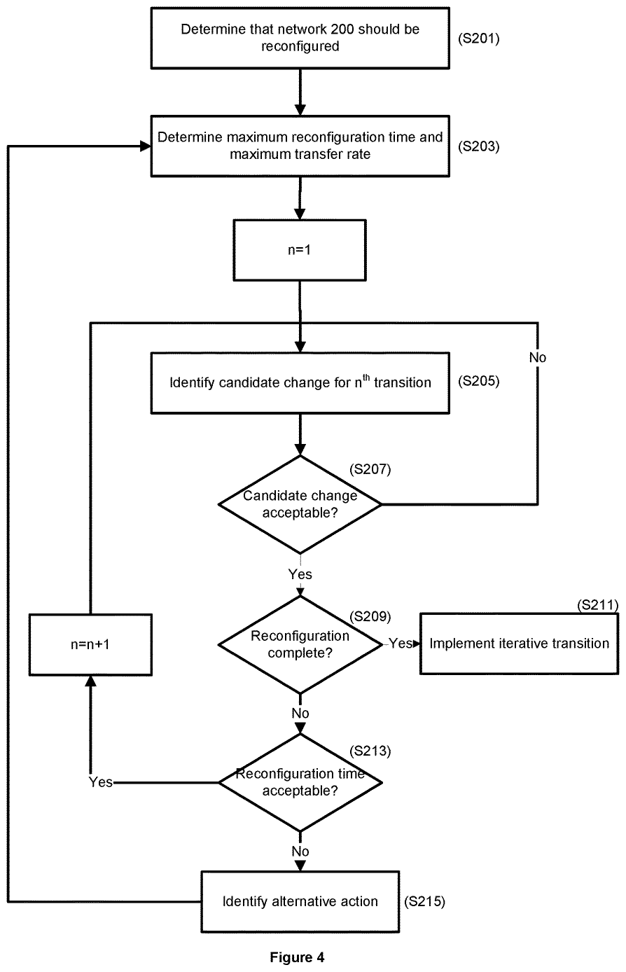

FIG. 4 illustrates an example implementation of the method of FIG. 3, again applied to the second wireless telecommunications network shown in FIG. 2. In S201, the method starts with a trigger event in which it is determined that the network 200 should be reconfigured. Again, the reconfiguration is to change the respective transmission powers of the first and second access points 210, 220 from their respective initial states (corresponding to the respective coverage areas 211, 221 of the first and second access points 210, 220 shown in FIG. 2a) to the respective transmission powers of the first and second access points 210, 220 in their respective final states (corresponding to the respective coverage areas 211, 221 of the first and second access points 210, 220 shown in FIG. 2d).

In S203, the network 200 determines a maximum reconfiguration time and a maximum transfer rate. The maximum reconfiguration time is the time limit to complete the entire reconfiguration. In other words, the time limit to complete all iterations of the iterative transition to implement the reconfiguration. This maximum reconfiguration time may be set as the time limit after which service is impacted. In this example, in which the iterations of the iterative transition are implemented in timesteps of equal duration, the maximum reconfiguration time is a certain number of timesteps. For example, the maximum reconfiguration time may be 5 timesteps.

The maximum transfer rate is the maximum number of user transfers that may occur in a timestep. This threshold may be set by the network operator based on an assessment of the acceptable maximum amount of additional signaling as a result of the user transfers. For example, the maximum transfer rate may be two transfers per timestep.

The network 200 then determines an iterative transition to implement the reconfiguration, in which the rate(s) of change are determined for each iteration. The rate(s) of change for all iterations are recorded before subsequent implementation in S211. Determination of the iterative transition begins by setting an initial transmission power value of the first access point 210 as the first access point's current transmission power and by setting an initial transmission power value of the second access point 220 as the second access point's current transmission power. These current transmission powers of the first access point 210 and second access point 220 at timestep T=0 are recorded in memory.

In S205, the network 200 determines a first transition of the iterative transition from timestep T=0 (in which the first and second access points use their respective initial transmission power values) to timestep T=1 by analyzing one or more candidate changes in transmission powers of the first and second access points 210, 220. A first candidate change in transmission powers of the first and second access points 210, 220 is analyzed in which the transmission power of the first access point 210 is increased by a predetermined amount and the transmission power of the second access point 220 is decreased by a predetermined amount. The respective increase and decrease in transmission powers of the first and second access points 210, 220 may represent the difference between the respective transmission power of the first and second access points 210, 220 in their respective final states and the respective transmission powers of the first and second access points 210, 220 in their respective initial states (such that the first and second access points 210, 220 would change from their initial states to their final states in a single transition).

In S207, it is determined whether the impact of the first candidate change is acceptable or not. This determination may be based on a comparison of an estimate of a rate of transfers of users as a result of the changes in transmission powers of the first and second access point 210, 220 to the maximum transfer rate (determined in S203). An estimation of the rate of transfers may be based on a function of an estimated count of user transfers as a result of the changes in transmission powers of the first and second access point 210, 220 and a time period between the timesteps T=0 and T=1. The estimated count of user transfers may be based on an estimated signal strength (e.g. Signal to Interference plus Noise Ratio, SINR) of the first and second access points 210, 220 when using their respective changed transmission powers at a location of each user of the plurality of users (which may be obtained from a location report from each user as determined by a Global Navigation Satellite System (GNSS), or any other user positioning system, such as those based on angle-of-arrival and timing advance) compared to a user transfer threshold.

If acceptable (that is, the estimated rate of transfers of users is less than or equal to the maximum transfer rate), then the first candidate change is accepted and the transmission powers of the first and second access point 210, 220 at timestep T=1 (as increased or decreased by their respective predetermined amounts) are recorded for timestep T=1. The first transition of the iterative transition from timesteps T=0 to T=1 is therefore determined.

If the first candidate change is not accepted (that is, the estimated rate of transfers of users is greater than the maximum transfer rate), then the network 200 analyzes a second candidate change in which the transmission power of the first access point 210 is increased by a predetermined amount and the transmission power of the second access point 220 is decreased by a predetermined amount. A magnitude of the increase in transmission power of the first access point 210 in the second candidate change is less than a magnitude of the increase in transmission power of the first access point 210 in the first candidate change, and/or a magnitude of the decrease in transmission power of the second access point 220 in the second candidate change is less than a magnitude of the decrease in transmission power of the second access point 220 in the first candidate change. S207 is repeated so as to determine whether the impact of the second candidate change is acceptable or not. Again, this determination may be based on a comparison of an estimate of a rate of transfer of users as a result of the changes in transmission powers of the first and second access points 210, 220 to the maximum transfer rate.

S205 and S207 are repeated iteratively until a candidate change is determined as acceptable. In each iteration of S205 to S207, a magnitude of a change in transmission power of at least one access point in the candidate change is reduced (relative to the magnitude in the change in transmission power of the respective access point of the previous iteration) such that the impact of the candidate change is reduced (relative to the impact of the candidate change in the previous iteration). The candidate change that is ultimately determined to be acceptable is therefore the maximum magnitude in change in transmission power (within the granularity of the reduction in magnitude in change in transmission power between iterations), such that the rate of change in transmission power is maximized within the limit set by the maximum transfer rate. Once it is determined that a candidate change is acceptable, then the transmission powers of the first and second access point 210, 220 at timestep T=1 (as respectively increased or decreased by the respective predetermined amount) are recorded. The first transition of the iterative transition from timesteps T=0 to T=1 is therefore determined.

In S209, the network 200 determines whether the respective transmission powers of the first and second access points 210, 220 at timestep T=1 complete the reconfiguration (i.e. they equal the transmission powers of the first and second access points 210, 220 of the final state shown in FIG. 2d). If so, then the process proceeds to S211 (explained later in the description). If not, then then the process proceeds to S213.

In S213, the network 200 determines whether a time period for the iterative transition when an iteration count for the iterative transition is increased by one is less than the maximum reconfiguration time. For example, following determination of the first transition of the iterative transition from timesteps T=0 to T=1 (as discussed above), the network 200 determines whether the time period to complete two transitions (from timesteps T=0 to T=2) is less than the maximum reconfiguration time. If not, then the process proceeds to S215 (explained later in the description). If yes, then the process loops back to S205 to determine a second transition of the iterative transition.

The second transition of the iterative transition is determined in the same manner as discussed above for the first transition by implementation of S205 and S207. That is, the network determines the second transition of the iterative transition from timestep T=1 (in which the first and second access points 210, 220 use their respective transmission power values as recorded for timestep T=1) to timestep T=2 by analyzing one or more candidate changes in respective transmission powers of the first and second access points 210, 220. Again, candidate changes in the respective transmission powers of the first and second access points 210, 220 are iteratively analyzed to identify the maximum magnitude respective changes in transmission powers that may be implemented within the constraints of the maximum transfer rate. Once a candidate change is accepted, the respective transmission powers of the first and second access points 210, 220 at timestep T=2 are recorded.

S205 to S213 are therefore repeated until one of the termination conditions of S209 or S213 is met. In an example, S205 to S213 are repeated until the network 200 determines an iterative transition-comprising a first transition (illustrated as the transition from FIG. 2a to FIG. 2b), a second transition (illustrated as the transition from FIG. 2b to FIG. 2c) and a third transition (illustrated as the transition from FIG. 2c to FIG. 2d)—completes the reconfiguration such that the termination condition of S209 is met. In response, the network 200 proceeds to S211 in which the first and second access points 210, 220 implement the iterative transition. This example implementation therefore provides the benefits of: 1) implementing the reconfiguration without exceeding the maximum transfer rate, 2) implementing the reconfiguration within the shortest amount of time, and 3) realizing incremental benefits of the reconfiguration at an earlier time (e.g. the benefits of transferring two users of the plurality of users are realized by timestep T1 in FIG. 2b compared to timestep T3 of FIG. 1d). These benefits are realized regardless of the user distribution. That is, the changes in transmission powers in each transition are tailored to the current locations of the plurality of users. The method is therefore adaptable to the current user distribution.

In another example, S205 to S213 are repeated until the network 200 determines that a time period for the iterative transition exceeds the maximum reconfiguration time, such that the termination condition of S213 is met. This determination indicates that it is not possible to satisfy the goal of reconfiguring within the maximum reconfiguration time without exceeding the maximum transfer rate. In response, in S215, the network 200 identifies an alternative action, such as selecting alternative respective final state transmission powers of the first and second access points 210, 220, increasing the maximum reconfiguration time, or increasing the maximum transfer rate. The process may then restart from S203 so as to identify an iterative transition for the new scenario.

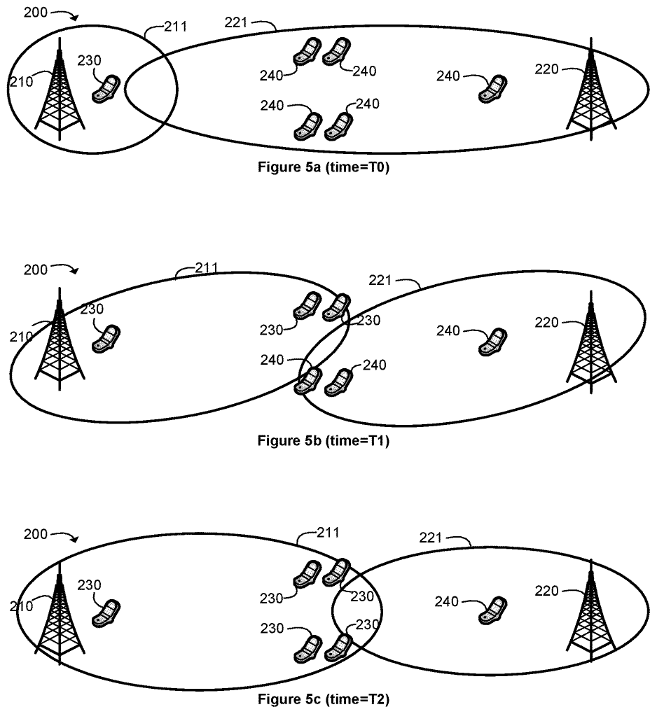

In the example implementation above (illustrated in FIG. 4), the iterative transition to implement the reconfiguration in transmission powers of the first and second access points 210, 220 was performed as a series of iterative transmission power changes. However, this is non-essential and the iterative transition may use alternative interim changes to the first and second access points 210, 220 so as to implement the reconfiguration without exceeding the maximum transfer rate. Another example implementation is illustrated in FIG. 5, in which the candidate change in each iteration is a change in beam shape (this may be implemented where the first and second access points 210, 220 have beamforming capabilities, such as by using Multiple Input Multiple Output (MIMO) antennas). These candidate changes in respective beam shape of the first and second access points may be analyzed alternatively or in addition to candidate changes in respective transmission power. An example implementation in which candidate changes in respective beam shape are considered is shown in FIG. 5a to FIG. 5c. An initial state of the network 200 of FIG. 5a mirrors the initial states shown in FIGS. 1a and 2a, in which the first access point 210 has an initial transmission power, the second access point 220 has an initial transmission power, and the plurality of users have the same locations.

In this example implementation, the network 200 determines an iterative transition in which a first transition (illustrated as the transition from FIG. 5a to FIG. 5b) involves the first access point 210 implementing a change to use a first beam shape and the second access point 220 implementing a change to use a second beam shape, resulting in two user transfers (and therefore satisfying the maximum user transfer rate). The iterative transition also includes a second transition (illustrated from FIG. 5b to FIG. 5c) which involves the first access point 210 implementing a change from the first beam shape to its final state, and the second access point 220 implementing a change from the second beam shape to its final state, which also results in two user transfers (and therefore satisfying the maximum user transfer rate).

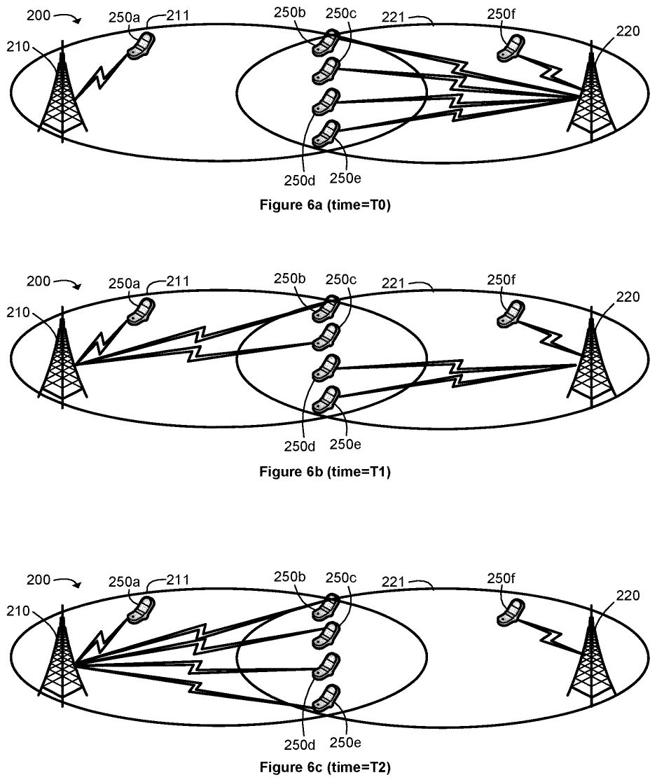

The above examples are based on a reconfiguration of the network 200 in which the first and second access points 210, 220 change their respective transmission characteristics (e.g. transmission power or beam shape). However, the skilled person will understand that the method may apply when implementing any reconfiguration of the network 200 which may cause additional resource usage. In another example, the network 200 determines that a reconfiguration of a handover threshold of one or more of a plurality of users (having the effect of transferring one or more users between the first and second access points 210, 220 without changing the first and/or second access points'respective transmission characteristics). This will now be explained with reference to FIG. 6a to 6c. FIG. 6a illustrates the first access point 210 and second access point 220 and a plurality of users 250a, 250c, 250c, 250d, 250e, 250f (collectively 250) in an initial state in which user 250a is connected to the first access point 210 and users 250b to 250f are connected to the second access point 220. All users of the plurality of users 250 are initially configured with the same handover threshold.

A trigger event may comprise a determination to implement load balancing between the first and second access points 210, 220 by reconfiguring the network so as to transfer users 250b, 250c, 250d, 250e from the second access point 220 to the first access point 210. To implement this reconfiguration, the network 200 determines an iterative transition in which a first iteration involves users 250b, 250c changing their respective handover thresholds such that a handover of users 250b, 250c to the first access point 210 is triggered (illustrated as the transition from FIG. 6a to FIG. 6b). The iterative transition also involves a second transition in which users 250d, 250e change their respective handover thresholds such that a handover of users 250d, 250e to the first access point 210 is triggered (illustrated as the transition from FIG. 6b to FIG. 6c). The reconfiguration of the network is therefore performed by an iterative transition (without reconfiguring the transmission characteristics of the first and second access points 210, 220) in which the rate of user transfers resulting from the change in each iteration is less than the maximum user transfer rate.

The change in handover thresholds for one or more respective users of the first and second access points 210, 220 therefore changes the network 200 from a scenario in which the plurality of users 250 all use the same handover threshold to a scenario in which one of a range of handover thresholds is used by each user of the plurality of users 250. It may be desirable to limit a magnitude in change in handover threshold (so as to limit the range of handover thresholds in the network 200 in its final state) as user performance may be sub-optimal when using the changed handover threshold. The change in handover threshold for each user may therefore be selected to balance opposing goals of triggering a handover (to balance load in the network 200) and minimizing the range of handover thresholds (to limit the negative impact on user performance as a result of the change in handover threshold).

The changes may comprise a combination of both a change in transmission characteristic (e.g. transmission power) and handover threshold. This may complicate the analysis of the rate of user transfer as a result of a candidate change in each iteration (and its comparison to the maximum transfer rate) in the event the change in handover threshold causes the user to transfer at an earlier time (relative to a time the user would have been transferred if the handover threshold of the user was unchanged), in which case the analysis also requires an analysis of the rate of user transfer in previous iterations (as a change in user threshold of one iteration may impact the rate of user transfer in one or more previous iterations).

Once the iterative transition has been determined, then the one or more users to be reconfigured as part of the iterative transition are reconfigured by a suitable instruction message (e.g. an RRCConnectionReconfiguration message). The change in handover threshold may be to an A3 event threshold (that is, the relative signal strength between the first and second access points), or any other handover threshold (such as time_to_trigger or hysteresis).

The change in handover thresholds of one or more users may alternatively be implemented following a trigger event in which the network 200 identifies a cluster of users (such as users 250b, 250c, 250d, 250e), and the network 200 determines that the handover thresholds of one or more users of the cluster of users should be proactively changed to forestall problems that may otherwise occur during a future access point reconfiguration. For example, the handover thresholds of users 250b to 250e may be changed such that they use one of a range of handover thresholds (the range may cover handover thresholds for a first set of the cluster of users that is higher than the current threshold, handover thresholds for a second set of the cluster of users that is the same as the current threshold, and/or handover thresholds for a third set of the cluster of users that is lower than the current threshold). These changes may not immediately trigger a handover between the first and second access points 210, 220. However, if the first and second access points 210, 220 subsequently change their transmission characteristics (which would otherwise have triggered a handover of users 250b to 250e at the same time), then these changes forestall any problems that would otherwise have been caused by such handovers (i.e. unmanageable additional resource usage) by spreading these handovers over a greater time period. In other words, as the first and second access points 210, 220 reconfigure, the different handover thresholds of the users of the cluster of users cause the handovers to occur at different time instances of the reconfiguration.

In examples where the reconfiguration concerns reconfiguration of an access point of the network, the skilled person will understand that the reconfiguration may concern only a single access point of the network. For example, a first access point may have a coverage area that is completely enclosed by the coverage area of a second access point (e.g. a small cell within the coverage area of a macro cell), and reconfiguration of the network may be to reduce the transmission power of the first access point which results in the transfer of the first access point's users to the second access point without any reconfiguration of the second access point.

In the above examples concerning a reconfiguration of multiple access points, the transitional changes to each access point were of the same type (e.g. a change in transmission power). However, the skilled person will understand that this is non-essential and the changes to different entities involved in the transitional change may be of different type. Furthermore, when the reconfiguration concerns multiple access points, the changes in each iteration may be performed in multiple stages. For example, in each iteration the first access point may increase its coverage area before the second access point decreases its coverage area so as to ensure that there is no break in an overlap of their respective coverage areas (which may otherwise result in loss of service for a user).

Furthermore, the iterative transitions detailed above are applied over timesteps of equal length, such that changes of different magnitude (applied over the equal length timesteps) result in a different rate of change. However, the skilled person will understand that these iterative transitions may involve differing rates of change by modifying one or both of the magnitude of change and time period for applying the change.

The change implemented in each transition of the iterative transition in the above examples may be selected to reduce the user impact of the change, such that users handed over as a result of the change are low-priority users (e.g. users with low-priority traffic such as low data rate or high latency services). Furthermore, in the example in which the handover threshold of one or more users is changed, then these changes may be applied to such low-priority users.

The skilled person will also understand that the rate of user transfer—and the corresponding additional signaling (i.e. spectral resource usage) as a result of these user transfers—is just one implementation of an assessment of whether the increase in resource usage as a result of the change in the network in each iteration is acceptable or not. The increase in resource usage may be based on, for example, additional processing resource and/or additional storage resource as a result of the change in the network. The increased resource usage may also be assessed based on other causes, such as a change in services in the network.

The skilled person will also understand that the determination of the maximum reconfiguration time is also non-essential. That is, the reconfiguration may take any amount of time, so long as the additional resource usage does not exceed the threshold at any time.

The skilled person will also understand that the methods detailed above may be performed by a central entity, which may be a core network entity, such as a Network Management System (NMS), or may be performed in a distributed manner, such as by being performed cooperatively by one or more entities involved in the reconfiguration.

The skilled person will also understand that the methods detailed above apply to other forms of wireless networks, including wireless local area networks and wireless wide area networks.

In the above examples, the location of each user is used to determine the impact of the change in each transition. This location may be time dependent (e.g. when the user is moving), which may also be taken into account to determine the relevant timestep to which the impact of the change is to be assessed.

In the process of FIG. 4, the candidate change selected for an iteration comprised the maximum magnitude in change in transmission power (within the granularity of the reduction in magnitude in change in transmission power between iterations), such that the rate of change in transmission power was maximized within the limit set by the maximum transfer rate. The skilled person will understand that this is non-essential, and that any change in transmission power within the limit set by a resource usage threshold may be used instead.

The skilled person will understand that any combination of features is possible within the scope of the disclosure, as claimed.

1. A method of reconfiguring a wireless telecommunications network, the method comprising:
obtaining data indicating a reconfiguration to be made to the wireless telecommunications network;
determining a plurality of transitions to implement the reconfiguration of the wireless telecommunications network, wherein it is determined, for each transition of the plurality of transitions:
a change in the wireless telecommunications network to partly implement the reconfiguration,
an amount of resource usage as a result of the change, and
that the amount of resource usage is less than a resource usage threshold, wherein a rate of change of a first transition of the plurality of transitions is different from a rate of change of a second transition of the plurality of transitions; and
causing implementation of the determined plurality of transitions.

2. The method as claimed in claim 1, wherein the change in the wireless telecommunications network of each transition of the plurality of transitions is determined by iteratively:
identifying a candidate change in the wireless telecommunications network to partly implement the reconfiguration, and
determining the amount of resource usage as a result of the candidate change,
until the amount of resource usage as a result of the candidate change is less than the resource usage threshold.

3. The method as claimed in claim 2, wherein a rate of a candidate change in an iteration is less than a rate of a candidate change in a previous iteration.

4. The method as claimed in claim 1, wherein the change in the wireless telecommunications network is one or more of a group comprising:
a change in transmission power of one or more access points,
a change in beam shape of one or more access points, and
a change in transfer threshold for one or more respective users of one or more access points.

5. The method as claimed in claim 1, wherein the determined amount of resource usage as a result of the change is one or more of a group comprising: a spectral resource usage, a storage resource usage, and a processing resource usage.

6. The method as claimed in claim 1, further comprising
comparing a time period to implement the plurality of transitions to a predetermined reconfiguration time threshold,
wherein causing implementation of the determined plurality of transitions is performed when the time period to implement the plurality of transitions is less than or equal to the predetermined reconfiguration time threshold.

7. The method as claimed in claim 6, wherein the time period to implement the plurality of transitions is greater than the predetermined reconfiguration time threshold, and the method further comprises:
modifying the reconfiguration by modifying one or more of a group comprising:
a final state of the wireless telecommunications network as reconfigured by the reconfiguration,
the predetermined reconfiguration time threshold, and
the resource usage threshold; and
determining a plurality of transitions to implement the modified reconfiguration of the wireless telecommunications network, wherein it is determined, for each transition of the plurality of transitions:
a change in the wireless telecommunications network to partly implement the modified reconfiguration,
an amount of resource usage as a result of the change, and
that the amount of resource usage is less than the resource usage threshold of the modified reconfiguration.

8. A data processing apparatus comprising a processor for carrying out the method of claim 1.

9. A computer program comprising instructions which, when the program is executed by a computer, cause the computer to carry out the method of claim 1.

10. A computer readable carrier medium comprising the computer program of claim 9.
